(19) United States
(12) Patent Application Publication
(10) Pub. No.: US 2002/0102193 A1
(43) Pub. Date: Aug. 1, 2002

(54) Process utilizing two zones for making single-wall carbon nanotubes

(75) Inventors: Richard E. Smalley, Houston, TX (US); Martin P. Grosboll, Kingwood, TX (US); Peter Athol Willis, Los Angeles, CA (US); W. Carter Kittrell, Houston, TX (US)

Correspondence Address: Ross Spencer Garsson, Winstead Sechrest & Minick P.C., 1201 Main Street, P.O. Box 50784, Dallas, TX, 75250-0784, US

(73) Assignee: William Marsh Rice University, Houston, TX

(21) Appl. No.: 10/059,871

(22) Filed: Jan. 29, 2002

Related U.S. Application Data
(60) Provisional application No. 60/265,646, filed on Jan. 31, 2001.

(51) Int. Cl. B01J 8/00; D01F 9/12

(52) U.S. Cl. 422/190; 423/447.3; 422/186.03

(57) ABSTRACT

The present invention discloses a gas-phase method for producing high yields of single-wall carbon nanotubes with high purity and homogeneity. The method involves separating the step of catalyst cluster formation from initiation and growth of the single-wall carbon nanotubes. The method involves reacting catalyst precursors and forming catalyst clusters of the size desirable to promote initiation and growth of single-wall carbon nanotubes prior to mixing with a carbon-containing feedstock at a reaction temperature and pressure sufficient to produce single-wall carbon nanotubes. The catalyst cluster reactions may be initiated either by rapid heating or by photolysis by high energy electromagnetic radiation, such as a laser, or both. The carbon feedstock gas for single-wall carbon nanotube synthesis is preferably CO or methane, catalyzed by the catalyst clusters, preferably iron or a combination of iron and nickel.

### CROSS-REFERENCES TO RELATED APPLICATIONS

This patent application claims priority from U.S. provisional application Ser. No. 60/265,646, filed Jan. 31, 2001, which application is incorporated herein by reference.

This patent application is related to U.S. patent application Ser. No. ______ , “PROCESS UTILIZING PRE-FORMED CLUSTER CATALYSTS FOR MAKING SINGLE-WALL CARBON NANOTUBES,” to Smalley et al., (Attorney Docket No.11321-P041US), filed concurrent herewith, and U.S. patent application Ser. No.______, “PROCESS UTILIZING SEEDS FOR MAKING SINGLE-WALL CARBON NANOTUBES,” to Smalley et al. (Attorney Docket No. 11321-P042US), filed concurrently herewith. Both of these U.S. patent applications are also incorporated herein by reference.

The present invention was made in connection with research pursuant to grant numbers NCC9-77 and R51480 from the National Aeronautics and Space Administration; grant number 36810 from the National Science Foundation; and grant numbers 99 003604-055-1999 and R81710 from the Texas Advanced Technology Program.

### FIELD OF INVENTION

The present invention relates broadly the field of single-wall carbon nanotubes, also known as tubular fullerenes or, commonly, “buckytubes.” More specifically, the invention relates to the production of single-wall carbon nanotubes in high yield and purity in a continuous process using a metallic catalyst with a carbon-containing feedstock at high temperature and pressure.

### BACKGROUND OF THE INVENTION

Fullerenes are spheroidal, closed-cage molecules consisting essentially of sp²-hybridized carbons typically arranged in hexagons and pentagons. Fullerenes, such as C₆₀, also known as Buckminsterfullerene, more commonly, “buckyballs,” and C₇₀, have been produced from vaporized carbon at high temperature. Presence of a transition catalyst with the high temperature vaporized carbon results in the formation of single-wall tubular structures which may be sealed at one or both ends with a semifullerene dome. These carbon cylindrical structures, known as single-wall carbon nanotubes or, commonly, “buckytubes” have extraordinary properties, including both electrical and thermal conductivity and high strength.

Nested single-wall carbon cylinders, known as multi-wall carbon nanotubes (MWNTs), possess properties similar to the single-wall carbon nanotubes (SWNTs); however, single-wall carbon nanotubes have fewer defects, rendering them stronger, more conductive, and typically more useful than multi-wall carbon nanotubes of similar diameter. SWNTs are believed to be much more free of defects than are MWNTs because the MWNT structure can admit defects in the form of bridges between the unsaturated carbon atoms of the neighboring cylinders, whereas SWNTs have no neighboring walls, which precludes the formation of inter-wall defects in SWNTs.

In defining the size and conformation of single-wall carbon nanotubes, the system of nomenclature described by Dresselhaus et al., Science of Fullerenes and Carbon Nanotubes, 1996, San Diego: Academic Press, Ch. 19, will be used. Single-wall tubular fullerenes are distinguished from each other by a double index (n, m), where n and m are integers that describe how to cut a single strip of graphene (a layer of graphite) such that its edges join seamlessly when the strip is wrapped into a cylindrical form. When n=m, the resultant single-wall carbon nanotube is said to be of the “arm-chair” or (n, n) type, since if the tube were cut perpendicularly to the tube axis, only the sides of the hexagons would be exposed and their pattern around the periphery of the tube edge would resemble the arm and seat of an arm chair repeated n times. When m=0, the resultant tube is said to be of the “zig zag” or (n,0) type, since a tube cut perpendicularly to the tube axis would expose an edge with a zig-zag pattern. Where n≠m and m≠0, the resulting tube has chirality. The electronic properties are dependent on the conformation, for example, arm-chair tubes are metallic and have extremely high electrical conductivity. Tube types are metallic, semi-metallic or semi-conductor, depending on their conformation. Regardless of tube type, all single-wall nanotubes have extremely high thermal conductivity and tensile strength.

Several methods of synthesizing fullerenes have developed from the condensation of vaporized carbon at high temperature. Fullerenes, such as C₆₀ and C₇₀, may be prepared by carbon arc methods using vaporized carbon at high temperature. Carbon nanotubes have also been produced as one of the deposits on the cathode in carbon arc processes.

Single-wall carbon nanotubes have been made in a DC arc discharge apparatus by simultaneously evaporating carbon and a small percentage of Group VIIIb transition metal from the anode of the arc discharge apparatus. These techniques allow production of only a low yield of carbon nanotubes, and the population of carbon nanotubes exhibits significant variations in structure and size.

Another method of producing single-wall carbon nanotubes involves laser vaporization of a graphite substrate doped with transition metal atoms (such as nickel, cobalt, or a mixture thereof) to produce single-wall carbon nanotubes. The single-wall carbon nanotubes produced by this method tend to be formed in clusters, termed “ropes,” of about 10 to about 1000 single-wall carbon nanotubes in parallel alignment, held by van der Waals forces in a closely packed triangular lattice. Nanotubes produced by this method vary in structure, although one structure tends to predominate. Although the laser vaporization process produces an improved yield of single-wall carbon nanotubes, the product is still heterogeneous, and the nanotubes tend to be too tangled for many potential uses of these materials. In addition, the laser vaporization of carbon is a high energy process.

Another way to synthesize carbon nanotubes is by catalytic decomposition of a carbon-containing gas by nanometer-scale metal particles supported on a substrate. The carbon feedstock molecules decompose on the particle surface, and the resulting carbon atoms then precipitate as part of a nanotube from one side of the particle. This procedure typically produces imperfect multi-walled carbon nanotubes, but, under the certain reaction conditions, can produce excellent single-wall carbon nanotubes.

Another method for production of single-wall carbon nanotubes involves the disproportionation of CO to form single-wall carbon nanotubes and CO₂ on transition metal particles comprising Mo, Fe, Ni, Co, or mixtures thereof residing on a support such as alumina. This method uses inexpensive feedstocks in a moderate temperature process. However, the yield is limited, and this limitation appears to be due to rapid surrounding of the catalyst particles by a dense tangle of single-wall carbon nanotubes, which acts as a barrier to diffusion of the feedstock and product gases, respectively, to and from the catalyst surface, limiting further nanotube growth.

Control of ferrocene/benzene partial pressures and addition of thiophene as a catalyst promoter in an all-gas-phase process can produce single-wall carbon nanotubes. However, this method suffers from simultaneous production of multi-wall carbon nanotubes, amorphous carbon, and other products of hydrocarbon pyrolysis under the high temperature conditions necessary to produce high quality single-wall carbon nanotubes.

More recently, a method for producing single-wall carbon nanotubes has been reported that uses high pressure CO as the carbon feedstock and a gaseous transition metal catalyst precursor as the catalyst. (“Gas Phase Nucleation and Growth of Single-Wall Carbon Nanotubes from High Pressure Carbon Monoxide,” International Pat. Publ. WO 00/26138, published May 11, 2000, incorporated by reference herein in its entirety). This method possesses many advantages over other earlier methods. For example, the method can be done continuously, and it has the potential for scale-up to produce commercial quantities of single-wall carbon nanotubes. Another significant advantage of this method is its effectiveness in making single-wall carbon nanotubes without simultaneously making multi-wall nanotubes. Furthermore, the method produces single-wall carbon nanotubes in high purity, such that less than about 10 wt % of the carbon in the solid product is attributable to other carbon-containing species, which includes both graphitic and amorphous carbon. A disadvantage of this method is that the conversion of CO to SWNT is relatively low.

While the method has several advantages over prior methods, there are still several aspects of the invention that have room for improvement. One is catalyst productivity, which directly affects both product purity and process economics. Another area for improvement is that of nanotube conformation homogeneity. “Conformation” means the particular diameter and chirality of the nanotube, as indicated by the (n,m) designation, e.g. the (10,10) tube. It is useful to be able to produce single-wall carbon nanotubes with the diameter and chirality best suited for a particular application.

Therefore, considering the foregoing, a need remains for improved methods of producing single-wall carbon nanotubes, with very high purity and homogeneity in processes with improved conversion efficiency of feedstock to SWNT.

### SUMMARY OF THE INVENTION

This invention relates to a method of producing single-wall carbon nanotubes of high purity, homogeneity at high yield. In the reaction of this method, single-wall carbon nanotubes are produced in a reaction zone at high temperature and pressure. The carbon source for the single-wall carbon nanotubes is a carbon-containing gas such as a hydrocarbon or CO, preferably carbon monoxide (CO), which is introduced in one stream into the reaction zone. Transition metal-containing compounds, which serve as catalyst precursors, are introduced in a separate stream into the reactor. Prior to introduction into the reaction zone, the carbon-containing gas feedstock is heated to a temperature, which after mixing with any catalyst containing stream, is sufficient to initiate and grow single-wall carbon nanotubes. Prior to introduction into the reaction zone, the catalyst precursor molecules are kept at under conditions (such as temperature, pressure and carrier gas mixture) at which they are stable. Just prior to entering the reaction zone, the catalyst precursors undergo chemical processes such as dissociation and subsequent reactions of the dissociated fragments, forming metal-containing clusters that serve as catalysts for the formation of single-wall carbon nanotubes in the reaction zone. The chemical processes in which the catalyst precursors participate may be initiated by their interaction with the feedstock gas in the reaction zone or feedstock gas in a separate catalyst formation zone through which the precursors pass prior to their entry to the reaction zone. This interaction with feedstock gas may be chemical (e.g. direct chemical reaction between the catalyst precursor and one or more components of the feedstock gas), physical (e.g. thermal heating by mixing with feedstock gas at an elevated temperature) or a combination thereof. Additional means for initiating the chemical processes in which the catalyst precursor reacts to form active catalyst may also be introduced in the reaction zone or a catalyst formation zone, such as introduction of additional reagents, application of heat to the reactor vessel in the region where the catalyst precursor is introduced, introduction of high energy electromagnetic excitation, and combinations thereof. The transition metal-containing compounds comprise one or more elements selected from the group consisting of the Group VIb elements (chromium, molybdenum, and tungsten) and the Group VIIIb elements (iron, nickle, cobalt, ruthenium, rhenium, palladium, osmium, iridium, and platinum).

Control and enhancement of the single-wall carbon nanotube homogeneity and yield are accomplished by providing highly uniform catalyst clusters in a size range conducive for the growth of single-wall carbon nanotubes. “Catalyst cluster” means an agglomeration of metal atoms that serve as a catalyst for the production of single-wall carbon nanotubes. The catalyst cluster contains at least one transition metal atom and generally, transition metal atoms in the catalyst cluster comprise more than 50 atom % of the cluster. For a number of reasons, catalyst clustering generally is a rate-limiting step in the synthesis of single-wall carbon nanotubes in the gas phase. By preparing the catalyst clusters in an appropriate size prior to entering the reaction zone, the variability in size of the catalyst clusters is minimized. Furthermore, the diameter of the resultant single-wall carbon nanotubes can be controlled by the size of the catalyst clusters supplied to the reaction zone.

Control of the cluster population and catalyst clustering dynamics is achieved by controlling the physical parameters and the chemical environment during clustering. By preparing the catalyst clusters prior to introduction into the reaction zone, the difficulties associated with the concurrent processes of catalyst cluster nucleation, catalyst cluster growth, initiation of SWNT and growth of SWNT can be avoided. The pre-forming of the catalyst cluster removes what is believed to be a rate-limiting step in previously-disclosed processes for SWNT growth, including, for example, the processes disclosed in International Pat. Pub. WO 00/26138. First, clustering is dependent on random collisions of the catalyst precursors and their reaction products with one another. Second, metal-metal binding energy in the intermediate species formed during clustering is a significant factor. Metals with low metal-metal binding energy are less apt to cluster and form less stable clusters. Third, the metal from the catalyst precursor is labile to chemical attack and reactions with CO, the CO being present from any dissociated carbonyl species used and/or CO used as the carbon feedstock gas at high temperature and pressure in the synthesis of single-wall carbon nanotubes. By forming the clusters in another gas than CO, the chemical attack by CO is minimized. Preferred gases are methane, other hydrocarbons, carbon dioxide, argon, nitrogen and other inert gases. Also, as the clusters grow, they are more stable against chemical attack because of the multiple metal-metal interactions in the cluster. Preforming the clusters under independently controlled conditions, and not under the prevailing conditions for initiating and growing single-wall carbon nanotubes, will allow the control over both the population and diameter of the catalyst clusters.

The various embodiments of the present invention provide improved methods of producing carbon nanotubes, especially single-wall carbon nanotubes, with very high purity, homogeneity and conformational control.

### BRIEF DESCRIPTION OF THE DRAWINGS

FIG. 1 shows a general schematic of flows in an apparatus for the production of single-wall carbon nanotubes in which a gas is used to introduce volatile or sublimable catalyst precursors for the growth of single-wall carbon nanotubes.

FIG. 2 shows a general schematic of flows in an apparatus useful for performing one embodiment of the present invention whereby the metal decomposition and clustering of the catalyst metals are done prior to the catalyst clusters entering the reactor for synthesis of the single-wall carbon nanotubes.

FIG. 3 shows a schematic of the apparatus useful for performing at least one embodiment of the present invention in which the transition metal precursors are photolyzed with a laser and the catalyst clusters are formed prior to the catalyst clusters entering the reactor for synthesis of the single-wall carbon nanotubes.

### DESCRIPTION OF ILLUSTRATIVE EMBODIMENTS

This invention relates to a method of producing single-wall carbon nanotubes of high purity and homogeneity at high catalyst yield. The invention relates to producing single-wall carbon nanotubes in high yield, homogeneity, and conformational control, by providing catalyst clusters of uniform size with which to initiate and grow single-wall carbon nanotubes.

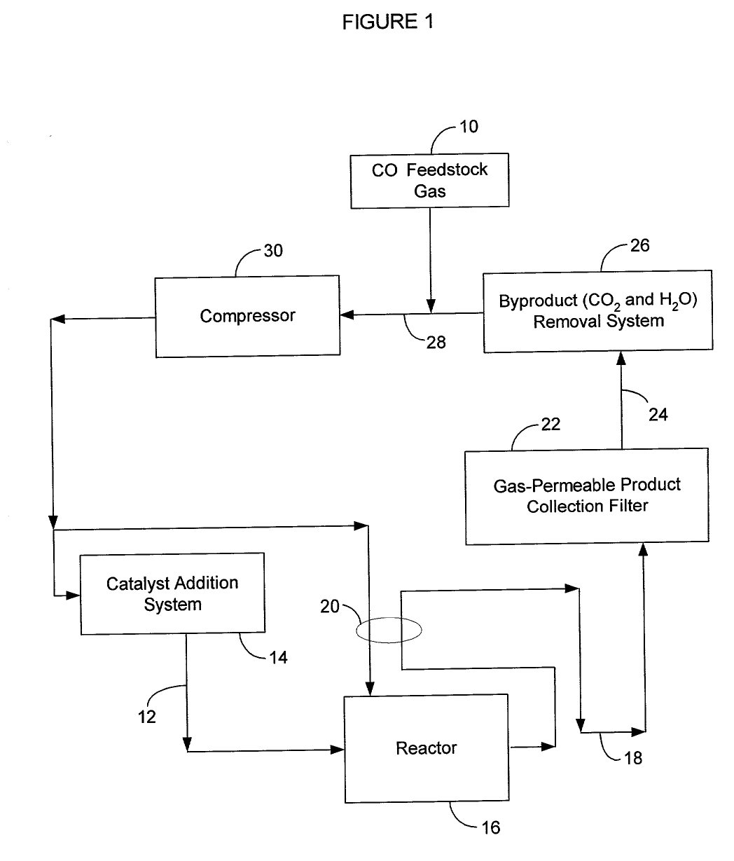

In order to more fully appreciate the scope of the present invention, FIG. 1 presents a schematic showing the general flows in an apparatus useful for performing one embodiment of the method. One of ordinary skill in the art will recognize that other apparatus could be used and are within the scope of the invention as presently claimed. The general scheme of the method includes a carbon feedstock gas (provided from a carbon feedstock gas source 10) and a catalyst stream (provided by flow 12 from a catalyst addition system 14) provided to a reactor 16 for the production of single-wall carbon nanotubes. In the case of the present invention, the catalyst stream represents a mixed gas stream comprising transition metal-containing catalyst precursors and a carrier gas. In the method, the carbon feedstock gas and the catalyst stream are mixed and single-wall carbon nanotubes are formed in the reactor. The single-wall carbon nanotubes, and any byproducts and residual catalyst, suspended in the gas resulting after nanotube synthesis, pass from the reactor in a product stream 18 and are collected on a gas-permeable product collection filter 22. An effluent stream 24, substantially free of single-wall carbon nanotube product, is fed to a byproduct removal system 26 to remove undesirable byproducts, such as CO₂ and H₂O, among others. A recycle stream 28, consisting essentially of pure carbon feedstock gas, is passed from the byproduct removal system to a compressor 30, where the recycle stream is brought to a desired pressure for recycling to the carbon feedstock gas flow, the catalyst addition system, or both, as desired. The carbon feedstock gas fed to the reactor is heated primarily by heaters inside the reactor, and, in part, by the hot product stream gas mixture passing from the reactor through a heat exchanger section 20.

A correlation between the diameter of single-wall carbon nanotubes and catalyst cluster size has been suggested in supported-metal chemical vapor deposition methods of synthesizing single-wall carbon nanotubes (Dai et al., Chem. Phys. Lett. 260:471 (1996)). In the synthesis of single-wall carbon nanotubes, the diameter and conformation of the nanotube is also expected to be correlated with the size of the catalyst cluster. Typically, the diameter of the growing carbon nanotube is proportional to the size of its active catalyst cluster at the time the carbon nanotube begins to grow. Factors that control the catalyst cluster size at the time of SWNT nucleation include the concentration of the catalyst precursor, the rate of clustering, the binding energies of the atoms in the clusters, the energy barrier for nanotube nucleation, the temperature during clustering, temperature during the synthesis of the single-wall carbon nanotubes, and the temperature, pressure and concentration of CO, which arises both from the decomposition of any metal carbonyl used as a catalyst precursor, as well as from CO when CO is used as the carbon-containing feedstock for single-wall carbon nanotube synthesis.

The catalyst cluster size, and, consequently, the single-wall carbon nanotube diameter, is expected to be affected by the ratio of feedstock molecules to catalyst precursor molecules. When CO is used as the carbon feedstock, a greater proportion of feedstock molecules to catalyst precursor molecules results in smaller catalyst clusters and thus smaller diameter carbon nanotubes. Conversely, a lower proportion of CO feedstock molecules to catalyst precursor molecules results in larger catalyst clusters and thus larger diameter single-wall carbon nanotubes.

Increasing the concentration of the transition metal precursor generally increases the rate of clustering and diameter of catalyst clusters. The single-wall carbon nanotube will initiate and grow on a catalyst cluster of a certain size range. If the cluster is too small, nanotubes will not be initiated and grow; if the cluster is too large, the catalyst cluster will overcoat with carbon and be inactive for nanotube growth.

Pressure of the carbon feedstock gas is another parameter capable of affecting catalyst cluster size and single-wall carbon nanotube diameter. When the feedstock is CO, higher pressures of the CO tend to result in smaller-diameter single-wall carbon nanotubes. Although not wanting to be held by theory, it is believed that higher CO pressures and concentrations counter clustering by reacting with the metal atoms from the catalyst precursors and forming various carbonyl species. Conversely, catalyst clustering in the presence of lower CO concentrations and pressures is expected to result in larger cluster diameters at the time of initiation of SWNT growth.

Reaction temperature is also a factor in the size of the catalyst clusters and the diameter of the single-wall carbon nanotubes. Generally, the diameter of the single-wall carbon nanotube decreases with increasing temperature. Although not wanting to be bound by theory, this may be due to metal atoms of the clusters evaporating and reducing the cluster size at higher nanotube synthesis temperatures, or it may be a consequence of more facile initiation of nanotube growth at elevated temperatures.

Another control mechanism involves the addition of a metal-containing nucleation agent, such as Ni(CO)₄, which promotes the aggregation of catalyst clusters. Nucleation agents that comprise metal atoms that have higher binding energies with iron and with each other than two iron atoms would have for one another, would enable the binding of two or more metal species that serves to initiate cluster growth. Generally, larger single-wall nanotubes have been observed with the use of nucleation agents. Although not wanting to be bound by theory, the larger diameter single-wall carbon nanotubes may be due either to the presence of larger catalyst clusters at the time the initiation of single-wall carbon nanotubes on the cluster or to a different rate and chemistry of initiation of formation of the tube on a catalyst cluster containing a different transition metal composition.

Initiating and growing single-wall carbon nanotubes on catalyst clusters with variable sizes lead to a distribution of sizes and conformations of single-wall carbon nanotubes. Size and conformation homogeneity of the single-wall carbon nanotube is directly related to initiation of nanotube growth on catalyst clusters of approximately the same size and in the range that produces the single-wall carbon nanotubes. Forming metal catalyst clusters of uniform size from the decomposition of metal catalyst precursor molecules, especially from mono-metallic species, in the reaction zone while concurrently forming single-wall carbon nanotubes on those clusters is difficult as it would, among other things, entail a complicated coordination of multiple events. First, since the catalyst clusters form by random collisions of the metal atoms, cluster growth is inherently difficult to control. Furthermore, since the reaction zone conditions are set primarily to optimize the initiation, growth and yield of single-wall carbon nanotubes, the optimum conditions for the growth of the catalyst clusters are not independently controlled. Although the operating parameters are not independently controlled to optimize cluster growth, the operating parameters appear to directly affect cluster size and the resulting diameter and yield of single-wall carbon nanotubes.

Conditions affecting single-wall carbon nanotube diameter also affect nanotube yield. Conventional means to increase yield and rates of production, may actually give the opposite result in the case of CO as a feedstock. Conventionally, higher yields in many processes can often be achieved with higher temperatures, pressures, catalyst and feed concentrations. In the case of CO as a carbon feedstock, single-wall carbon nanotube yield decreases at temperatures above 1050° C. Higher yields are observed at higher pressures when accompanied with higher catalyst concentrations. (See Bronikowski, et. al., J. Vac. Sci. Technol. A 19:1800 (2001)). The need remains for a process that will provide high yields of single-wall carbon nanotubes with independent control of the single-wall carbon nanotube diameter and conformation.

Using CO as a carbon-feedstock, transition metal catalysts are needed to catalyze the Boudouard reaction (CO+CO→C+CO₂) to provide carbon for nanotube growth. Transition metal catalyst precursors used in the process for synthesizing single-wall carbon nanotubes are often carbonyls of Group VIb and Group VIIIb transition metal elements, although other transition catalyst precursors like ferrocene, nickelocene and cobaltocene may also be used. Of the mono-metallic carbonyls, iron pentacarbonyl and nickel tetracarbonyl are preferred. In the process, the transition metal precursor molecules may be dissociated by heat as they enter the reaction zone. Upon heating, the catalyst precursor reaction products cluster and form the catalyst for nanotube synthesis. Besides the initiation and nucleation of the single-wall carbon nanotube on the cluster, the clustering of the metal atoms is also believed to be a rate-limiting step in the growth of single-wall carbon nanotubes in the process. The catalyst clustering is complicated by reactions involving various metal carbonyl species. Also working against the desired clustering is weak metal-metal bonding. In the case of iron, the binding energy for a Fe—Fe dimer is on the order of 1 eV. It is possible and desirable to add nickel to the catalyst to improve the nucleation and clustering because the Ni-Ni binding energy is on the order of 2 eV, or approximately twice that of iron.

The obstacles to cluster formation in the reaction zone while simultaneously initiating and growing single-wall carbon nanotubes, including reverse reactions with CO and low metal-metal binding energies, are solved or minimized in the present invention by preforming the catalyst clusters in a catalyst-formation zone prior to introduction into the reaction zone for synthesizing single-wall carbon nanotubes. In this way, the cluster size and population can be controlled independent of the conditions in the reaction zone. Increasing the catalyst cluster population introduced into the reaction zone will increase the yield of single-wall carbon nanotubes. The formation of the catalyst clusters is controlled so as to form the desired cluster diameter to yield the single-wall carbon nanotube diameter and conformation desired. Conditions that can be controlled in clustering are heating rate of the catalyst precursors, clustering temperature, residence time and chemical environment, including its chemical composition, temperature and pressure. Of these parameters, a non-CO gas, such as an inert gas, CO₂, methane or other small hydrocarbon will minimize the CO reaction with the metal atoms undergoing clustering. Although a non-CO carrier gas will not prevent CO from being present if a metal carbonyl is used as a catalyst precursor, a non-CO gas will, at least, greatly reduce the CO reaction with metal atoms dissociated from the catalyst precursor. A catalyst precursor other than a carbonyl, such as ferrocene, in a non-CO carrier gas would eliminate the presence of CO, and the complications it causes in the catalyst clustering process, entirely.

Initiation of cluster formation from the catalyst precursor can be accomplished in several ways described above. In all cases, clustering of the metal atoms from the precursor is better controlled in the catalyst-formation zone of the present invention such that the desired catalyst cluster diameter is achieved. Preforming the catalyst clusters prior to introducing them into the reactor, permits the initiation and growth of the single-wall carbon nanotube to proceed expeditiously. The yield can be increased by increasing the amount of catalyst clusters fed to the reaction zone of the reactor. The size of the catalyst clusters, and the corresponding diameter and conformation of the single-wall carbon nanotubes formed, are controllable by controlling the clustering parameters of heating rate, precursor concentration, carrier gas, residence time and clustering incubation temperature.

In one embodiment, the transition catalyst precursor molecules are decomposed and catalyst clusters preformed in a catalyst-formation zone of the apparatus prior to the catalyst entering the reaction zone where the single-wall carbon nanotubes are synthesized with a carbon-containing feedstock, such as carbon monoxide. Prior to entering the catalyst-formation zone, the catalyst precursor molecules are kept at a temperature below the decomposition temperature of the precursor molecules. In the catalyst-formation zone, which is connected to, but in an area separate from, the reaction zone, the catalyst precursor molecules are heated at least to a temperature sufficient to initiate catalyst clustering. The catalyst precursor molecules preferably contain elements from Group VIb, Group VIIIb, or combinations thereof. The catalyst precursor is introduced into the catalyst-formation zone in a carrier gas stream, which may be CO, but is preferably a non-CO gas, such as an inert gas, methane, other hydrocarbons, and mixtures thereof.

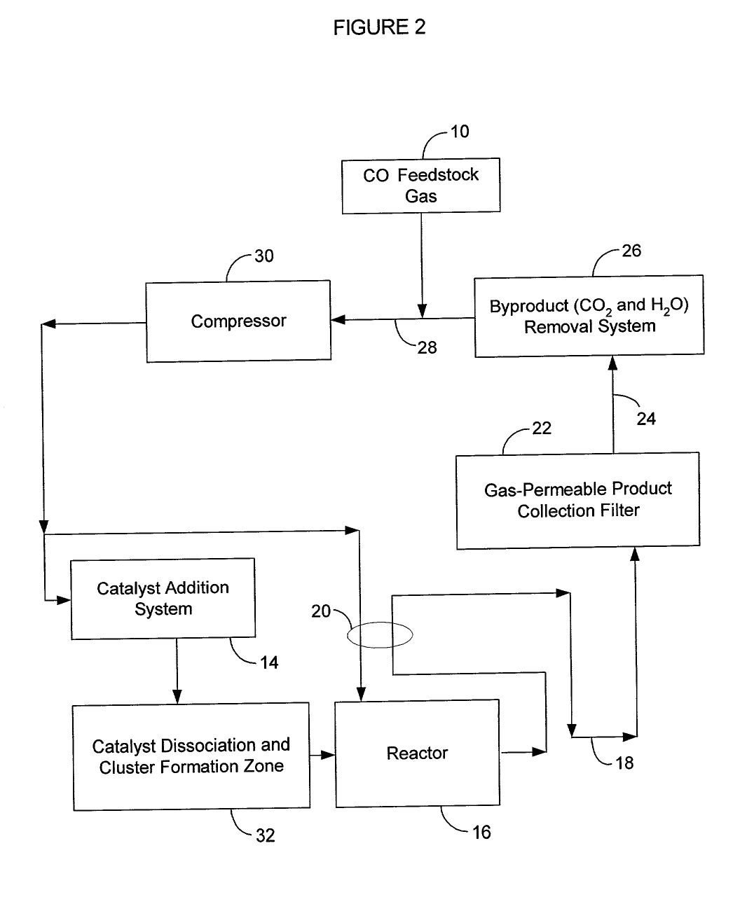

FIG. 2 illustrates a schematic of this embodiment. In addition to the components and flows as given in FIG. 1, this embodiment incorporates a cluster formation zone 32. In this zone, the temperature and residence time are controlled to produce the catalyst clusters of the desired size for introduction into the reactor 16 for the production of single-wall carbon nanotubes. The temperature of the catalyst-formation zone is held at or above the temperature needed to initiate clustering reactions in the catalyst precursors used. This temperature is typically in excess of 100° C., more typically in excess of 500° C. The residence time in the catalyst-formation zone is dependent on the desired cluster size. Preferably, the catalyst precursor reaction is initiated by rapid heating, i.e. in less than about 10 msec. The catalyst-formation zone is connected adjacent to the reactor, such that as soon as the catalyst clusters of the desired size are formed, they enter the reactor and are mixed rapidly with the carbon-containing feedstock and immediately begin initiating and growing single-wall carbon nanotubes.

In this embodiment, the present invention relates to a method for producing single-wall carbon nanotubes, comprising (a) providing a catalyst precursor gas stream comprising (i) a carrier gas and (ii) a catalyst precursor comprising a plurality of catalyst precursor molecules, wherein the catalyst precursor molecules comprise one or more atoms of at least one transition metal selected from the group consisting of Group VIb elements and Group VIIIb elements, and wherein the catalyst precursor gas stream is at a temperature at which the catalyst precursor is stable; (b) heating the catalyst precursor gas stream to form a heated catalyst gas stream, wherein the heated catalyst gas stream is at a temperature sufficient to promote the initiation and growth of catalyst clusters and to form a suspension of catalyst clusters in the heated catalyst gas stream; (c) providing a carbon feedstock gas stream at a temperature above the minimum single-wall carbon nanotube formation initiation temperature; and (d) mixing the carbon feedstock gas stream with the heated catalyst gas stream to form a mixed gas stream, wherein the catalyst clusters reach a temperature sufficient to promote the initiation and growth of single-wall carbon nanotubes on the catalyst clusters and to form a product gas stream comprising the single-wall carbon nanotubes.

The carrier gas for the catalyst precursor may be selected from any gas known to one of ordinary skill in the art, and may be selected for reasons of price or convenience, in addition to the physical and chemical parameters of the gas. The carrier gas may be purified before use, such as by filtration or other purification processes. Some or all of the carrier gas for the catalyst precursor gas stream may be obtained from recycling of gaseous effluent from later steps of the process. Although it is possible to use CO as a carrier gas, other non-CO carrier gases such as CO₂, inert gases, methane and other small hydrocarbons do not have the propensity like CO to chemically attack the metal atoms dissociated from the catalyst precursor molecules. The advantage of CO as a catalyst precursor carrier gas is that gas purification of the reactor effluent gas is simplified. Presence carrier gases other than CO will typically require additional removal procedures and/or purification capacity to remove the non-CO carrier gas or byproducts therefrom in the recycle gas stream before the carbon nanotube feedstock stream is fed back to the reactor for making single-wall carbon nanotubes. Preferably, the carrier gas is selected from CO, CO₂, methane, argon, nitrogen, or mixtures thereof. More preferably, the carrier gas is selected from CO, methane, or mixtures thereof. The carrier gas for the catalyst precursor gas stream can be provided at any desired pressure. The pressure of the carrier gas is supplied at a pressure greater than the reactor pressure for making single-wall carbon nanotubes. Preferably, the carrier gas pressure is from about 3 atm to about 1000 atm, more preferably from about 5 atm to about 500 atm. The carrier gas for the catalyst precursor flow, upstream of the catalyst-formation region, can be at any temperature at which the catalyst precursor is stable. Preferably, however, the temperature of the carrier gas stream is sufficient to volatilize or sublime the catalyst precursor.

Typically, the catalyst precursor may comprise one or more metal atoms, wherein the metal is selected from the transition metals of Group VIb, Group VIIIb, or both. Suitable metals include, but are not limited to, tungsten, molybdenum, chromium, iron, nickel, cobalt, rhodium, ruthenium, palladium, osmium, iridium, platinum, and mixtures thereof. Iron and cobalt are preferred metals. Also, the catalyst precursor typically comprises one or more non-metal atoms. The catalyst precursor will inherently have a decomposition or dissociation temperature, at or above which the non-metal atoms of the catalyst precursor will dissociate from the metal atom(s). Preferably, the catalyst precursor is a volatile or sublimable molecule. In one embodiment, the catalyst precursor is ferrocene. In one preferred embodiment, the catalyst precursor comprises a metal carbonyl. More preferably, the metal carbonyl can also be selected from Fe(CO)₅, Ni(CO)₄, or a mixture thereof. The concentration of the catalyst precursor in the catalyst precursor gas stream can be, preferably, between about 1 ppm and about 100 ppm, more preferably between about 5 ppm and about 50 ppm.

The catalyst precursor can be introduced into the carrier gas by any appropriate technique. If the catalyst precursor is a liquid, the carrier gas can be bubbled through the catalyst precursor to make a catalyst precursor stream. If the catalyst precursor is a sublimable solid, the solid can be heated and the carrier gas passed through the vapor. After the catalyst precursor is in the carrier gas, the catalyst precursor stream is heated by any appropriate technique to a temperature at or above the decomposition temperature of the catalyst precursor. The catalyst precursor gas stream can be heated by mixing with additional heated carrier gas. Another means of heating the catalyst precursor stream is with heating elements in the walls of the apparatus containing the catalyst precursor stream. The catalyst formation temperature, heating rate, and time at the desired temperature, pressure and chemical environment, are dependent on the particular catalyst precursor selected. The conditions are selected to permit formation of catalyst clusters of the size sufficient to initiate and grow single-wall carbon nanotubes when introduced into the reactor for making single-wall carbon nanotubes. Catalyst clusters of the size from about 0.5 nm to about 3 nm are desired for the initiation and growth of single-wall carbon nanotubes. Preferably the catalyst clusters are of the size from about 0.5 nm to about 2 nm. If the catalyst clusters grow too large, the clusters will not form single-wall carbon nanotubes, but rather overcoat with other forms of carbon.

Catalyst cluster formation and stability is highly dependent on the metal-metal binding energy. For iron, the metal-metal binding energy is relatively low (roughly 1 eV), and therefore iron clustering is more difficult and less stable at higher temperatures, such as in the range of initiation and growth of single-wall carbon nanotubes from about 850° C. to about 1050° C. The rate and stability of clustering is increased with the addition of a nucleating agent which includes a metal with a greater metal-metal binding energy. Where iron is the intended component of the catalyst cluster, nucleating agents containing nickel, molybdenum or tungsten, such as Ni(CO)₄, may be used to promote and stabilize clustering. In the case of nickel, the metal-metal binding energy is roughly 2 eV, or roughly twice that of iron. Additionally, a small amount of oxygen (such as, e.g., N₂O, NO₂, O₂ and O₃) may be added to promote clustering.

After the catalyst clusters of the desired size are formed in the catalyst precursor stream, the clusters are introduced into the reactor where they are mixed with a carbon-containing feedstock heated to a temperature above the minimum temperature required for single-wall carbon nanotube initiation and growth on the catalyst cluster. The carbon feedstock gas may be any carbon-containing gas that will undergo a reaction in the presence of an appropriate catalyst under appropriate reaction conditions to provide carbon to initiate or grow a single-wall carbon nanotube. Some portion of the carbon feedstock gas may be provided from a high purity source or from purified recycled gas from the reactor effluent. Preferably, the carbon feedstock gas is selected from CO, hydrocarbons, or mixtures thereof. If the carbon feedstock gas stream comprises methane or other hydrocarbons, it preferably further comprises an amount of hydrogen, a sulfur compound, or both sufficient to promote catalysis. The pressure of the carbon feedstock gas can be at any pressure, but is preferably superatmospheric in order to accelerate single-wall carbon nanotube initiation and formation on the catalyst clusters. If the carbon feedstock gas stream comprises CO, more preferably, P_{CO} is from about 3 atm to about 1000 atm.

The mixing of the carbon feedstock stream and stream containing the catalyst clusters can be performed by any appropriate technique known in the art. Preferably, the mixing step is substantially complete in less than about 10 msec. After the heated carbon feedstock gas is mixed in the reactor with the gas stream containing the catalyst clusters, the temperature of the combined stream is at a temperature sufficient to promote the initiation and growth of single-wall carbon nanotubes on the catalyst clusters, resulting in a mixed gas stream comprising single-wall carbon nanotubes in suspension. The temperature of the combined gas stream is greater than 500° C., but preferably, the temperature of the combined gas stream is at least about 850° C. More preferably, the temperature of the combined gas stream is at least about 900° C. If CO is the predominant carbon feedstock gas, carbon is obtained from disproportionation of CO via the Boudouard reaction, with the catalyst cluster catalyzing the addition of carbon to the growing end of a single-wall carbon nanotube.

Generally, the synthesis of single-wall carbon nanotubes in this method is done at superatmospheric pressure and elevated temperatures to promote fast reaction rates and to anneal and correct defects in single-wall carbon nanotubes as the defects are formed. High pressure also accelerates the initiation of the single-wall carbon nanotubes on the pre-formed catalyst clusters before the catalyst clusters aggregate to a size where they no longer catalyze single-wall carbon nanotube formation. High pressure also accelerates the formation of single-wall carbon nanotubes in the Boudouard reaction using CO as the carbon feedstock. Superatmospheric pressures of about 3 atm to about 1000 atm are preferred. More preferred are superatmospheric pressures of about 5 atm to about 500 atm.

In another embodiment of the invention, the transition metal precursor molecules are decomposed by a laser prior to entering the reaction zone for making single-wall carbon nanotubes. In this case, the transition metal precursor molecules are mixed with a carrier gas and kept at a temperature at which the catalyst precursor is stable. Just prior to entering the reaction zone for synthesis of the single-wall carbon nanotubes, the transition metal precursor molecules are photolyzed by a beam of high energy monochromatic electromagnetic radiation, such as from a laser beam, focused on the gas stream. “Photolysis” means chemical decomposition by the action of radiant energy. Preferably, the high energy monochomatic electromagnetic radiation will be selected so that it will be primarily absorbed by the transition metal precursor and minimally absorbed by the carrier gas. The metal atoms from the photolyzed precursor molecules cluster prior to entering the reaction zone for nanotube synthesis. By controlling the physical parameters and the chemical environment of the catalyst precursor stream, the size of the catalyst clusters can be controlled prior to introduction to the reaction zone for the synthesis of the single-wall carbon nanotubes. The residence time for clustering is controlled so as to produce clusters of sufficient size to catalyze the formation and growth of single-wall nanotubes, but not so large as to immediately overcoat with carbonaceous material, such as amorphous or graphitic carbon.

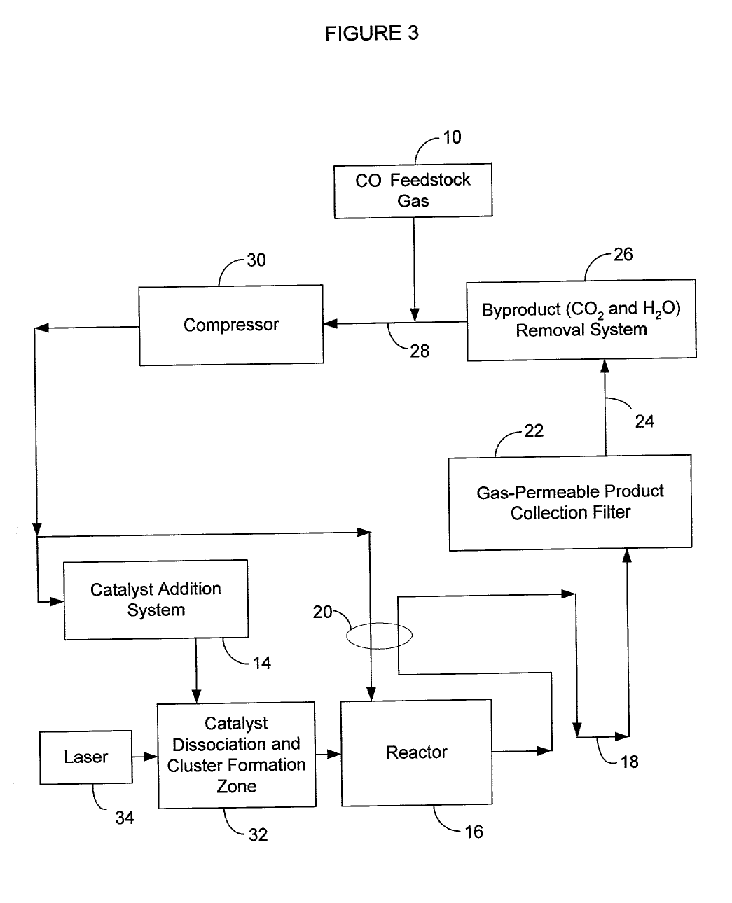

FIG. 3 illustrates a schematic of this embodiment. In addition to the components and flows as given in FIG. 2, this embodiment incorporates an electromagnetic radiation source, such as a laser 34, to photolyze the catalyst precursor. As in the previous embodiment, the catalyst precursor enters a separate zone for clustering 32. Upon entering the zone, the catalyst precursor is photolyzed with electromagnetic radiation, such as the shown laser, and cluster formation takes place at a temperature and for a period of time to achieve the desired cluster size for introduction into the reactor 16 for the production of single-wall carbon nanotubes. As in the earlier embodiment, the catalyst-formation zone is connected adjacent to the reactor, such that as soon as catalyst clusters of the desired size are formed, they enter the reactor and are mixed rapidly with the carbon-containing feedstock and immediately begin initiating and growing single-wall carbon nanotubes. In this embodiment, the present invention relates to a method for producing single-wall carbon nanotubes, comprising (a) providing a catalyst precursor gas stream comprising (i) a carrier gas and (ii) a catalyst precursor comprising a plurality of catalyst precursor molecules, wherein the catalyst precursor molecules comprise one or more atoms of at least one transition metal selected from the group consisting of Group VIb elements and Group VIIIb elements, and wherein the catalyst precursor gas stream is at a temperature at which the catalyst precursor is stable; (b) subjecting the catalyst precursor gas stream to electromagnetic radiation, wherein the electromagnetic radiation provides sufficient energy to photolyze the catalyst precursor and promote the initiation and growth of catalyst clusters and to form a catalyst cluster gas stream comprising a solution or a suspension of catalyst clusters; (c) providing a carbon feedstock gas stream at a temperature above the minimum single-wall carbon nanotube formation initiation temperature; and (d) mixing the carbon feedstock gas stream with the catalyst cluster gas stream to form a mixed gas stream, wherein the catalyst clusters reach a temperature sufficient to promote the initiation and growth of single-wall carbon nanotubes on the catalyst clusters and to form a product gas stream comprising the single-wall carbon nanotubes. This embodiment is similar to the first embodiment except that a different means of initiating cluster formation from the catalyst precursor molecules is presented.

In the photolysis, the catalyst precursor gas stream is subjected to electromagnetic radiation. This radiation may be incoherent, such as that from a flashlamp or, alternatively, may be substantially coherent substantially monochromatic electromagnetic radiation. “Substantially coherent substantially monochromatic electromagnetic radiation” means electromagnetic radiation wherein at least about 90% of the energy of the radiation is possessed by photons having a wavelength within about 5 nm longer or shorter than a peak wavelength. A laser is an exemplary source of such substantially coherent substantially monochromatic electromagnetic radiation.

The energy of the electromagnetic radiation desirably is sufficient to photolyze the catalyst precursor. Desirably, the energy output of the radiation source is greater than the amount of energy required to dissociate nonmetal atoms from the catalyst precursor, to compensate for energy of the radiation that may be absorbed by molecules in the gas stream other than the catalyst precursor, that may be associated with photons that pass through the catalyst precursor gas stream without imparting their energy to molecules in the catalyst precursor gas stream, or that may otherwise not contribute to dissociation of nonmetal atoms from the catalyst precursor.

The required energy output of the radiation source sufficient to photolyze the catalyst precursor will depend on the peak wavelength of the radiation, the ability of molecules in the gas stream other than the catalyst precursor to absorb radiation at or near the peak wavelength, the duration time, and other parameters that will be apparent to one of ordinary skill in the art. Preferably, the substantially coherent substantially monochromatic electromagnetic radiation has a peak wavelength of about 200 nm to about 300 nm. An exemplary source of such radiation with such a peak wavelength is a KrF laser (peak wavelength about 248 nm). Typically, with the KrF laser described above, the duration time is sufficient to substantially completely dissociate nonmetal atoms from the catalyst precursor.

After photolysis of the catalyst precursor, the initiation and growth of the catalyst clusters proceeds substantially in a heated carrier gas or in a gas stream externally heated. The result of this initiation and growth is a catalyst cluster gas stream comprising a suspension of catalyst clusters. This catalyst cluster gas stream can be fed to the reactor and mixed with the carbon-containing feedstock gas at a temperature sufficient for the initiation and growth of single-wall carbon nanotubes on the catalyst clusters. The product of the reaction is a suspension of single-wall carbon nanotubes in a mixed gas stream. The single-wall carbon nanotubes are recovered from the gas stream with an inline gas-permeable filter or by any other appropriate technique.

One benefit of the present invention is that carbon nanotubes typically initiate and grow rapidly on the catalyst clusters. This rapid growth soon leads to long carbon nanotubes. Collisions between particles of catalyst cluster are thus generally inhibited because the long carbon nanotubes growing thereon dominate the collision and inhibit aggregation of the catalyst clusters into larger clusters that are more likely to become inactive.

The embodiments of the present invention provide an improved method of producing a single-wall carbon nanotube product comprising single-wall carbon nanotubes with very high purity and homogeneity. The single-wall carbon nanotubes in the product may be separate, grouped in bundles of one or more nanotubes or in the form of ropes, comprising 10 or more nanotubes, wherein the single-wall carbon nanotubes in the bundles or ropes are generally aligned and held together by van der Waals forces. The single-wall carbon nanotubes in the product are of high purity and can be used in many applications without further purification steps. However, for certain applications, purification of the single-wall carbon nanotube product may be performed by techniques known to those of ordinary skill in the art.

The single-wall carbon nanotube product of the present invention contains little, if any, amorphous carbon and contains only minor amounts of catalyst atoms. Generally, the amount of catalyst remaining is less than about 5 to 7 atom %. Preferably, the amount of catalyst is less than about 4 atom %. More preferably, the amount of catalyst is less than about 2 atom %.

The present invention provides for a single-wall carbon nanotube product which comprises mostly single-wall carbon nanotubes and only minor amounts of other carbon species, such as amorphous carbon and other graphitic carbon forms. Of all the carbon atoms in the carbon nanotube product of the present invention, it is feasible that at least about 90% of the carbon atoms can be in the form of single-wall carbon nanotubes. Preferably, at least about 95% of the carbon atoms in the nanotube product are in the form of single-wall carbon nanotubes. More preferably, at least about 99% of the carbon atoms in the nanotube product are in the form of single-wall carbon nanotubes.

One of the advantages of the present invention is that there is a high level of control over the diameter and conformation of the single-wall carbon nanotubes produced. This diameter and conformation control is predominantly due to the homogeneity of the catalyst clusters supplied to the reaction zone. The diameter and conformation of the single-wall carbon nanotubes produced can be generally in the size and type desired. In general, single-wall carbon nanotube diameters are in the range of about 0.6 nm to about 3 nm. The preferred diameter range of the single-wall carbon nanotubes produced is dependent on the application of use. The single-wall carbon nanotubes may possess any possible conformation or geometry, e.g. armchair, zigzag, or others. The preferred conformation or geometry is dependent on the application of use. The length of the single-wall carbon nanotubes is highly dependent upon the residence time, temperature, pressure, and other parameters in the reactor for nanotube production. The preferred length of the single-wall carbon nanotubes is also dependent on the application of use.

The carbon nanotubes produced may be used for any application known to one of ordinary skill in the art. Such applications include, but are not limited to, electrical connectors in microdevices (e.g., integrated circuits or semiconductor chips), antennas, optical antennas, probes for scanning tunneling microscopy (STM) or atomic force microscopy (AFM), additive to or substitute for carbon black (in, e.g., motor vehicle tires), catalysts in industrial and chemical processes, power transmission cables, solar cells, batteries, molecular electronics, probes, manipulators, and composites, among others.

All of the compositions and methods disclosed and claimed herein can be made and executed without undue experimentation in light of the present disclosure. While the compositions and methods of this invention have been described in terms of preferred embodiments, it will be apparent to those of skill in the art that variations may be applied to the compositions and methods and in the steps or in the sequence of steps of the method described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

What is claimed is:

1. A method for producing single-wall carbon nanotubes, comprising:
(a) providing a catalyst precursor gas stream comprising
(i) a carrier gas and
(ii) a catalyst precursor comprising a plurality of catalyst precursor molecules, wherein the catalyst precursor molecules comprise one or more atoms of at least one transition metal selected from the group consisting of Group VIb elements and Group VIIIb elements, and wherein the catalyst precursor gas stream is at a temperature at which the catalyst precursor is stable;
(b) heating the catalyst precursor gas stream to form a heated catalyst gas stream, wherein the heated catalyst gas stream is at a temperature sufficient to promote the initiation and growth of catalyst clusters and to form a suspension of catalyst clusters in the heated catalyst gas stream;
(c) providing a carbon feedstock gas stream at a temperature above the minimum single-wall carbon nanotube formation initiation temperature above the minimum single-wall carbon nanotube formation initiation temperature; and
(d) mixing the carbon feedstock gas stream with the heated catalyst gas stream to form a mixed gas stream, wherein the catalyst clusters reach a temperature sufficient to promote the initiation and growth of single-wall carbon nanotubes on the catalyst clusters and to form a product gas stream comprising the single-wall carbon nanotubes.

2. The method of claim 1, wherein the carrier gas comprises a hydrocarbon gas.

3. The method of claim 1, wherein the carrier gas comprises a gas selected from the group consisting of CO, CO₂, methane, argon, nitrogen, and mixtures thereof.

4. The method of claim 1, wherein the catalyst precursor comprises a metal carbonyl.

5. The method of claim 4, wherein the metal carbonyl is selected from the group consisting of Fe(CO)₅, Ni(CO)₄, and mixtures thereof.

6. The method of claim 1, wherein the heating of the catalyst precursor stream is done with a heating gas comprising a gas selected from the group consisting of CO, argon, nitrogen, and mixtures thereof.

7. The method of claim 1, wherein the heating of the catalyst precursor gas stream is done with a heating element.

8. The method of claim 1, wherein the temperature of the heated catalyst gas stream is at least about 100° C.

9. The method of claim 8, wherein the temperature of the heated catalyst gas stream is at least about 500° C.

10. The method of claim 1, wherein the catalyst precursor is heated by mixing the catalyst precursor gas stream with a heating gas stream, wherein the heating is substantially complete in less than about 10 msec.

11. The method of claim 1, wherein the carbon feedstock gas stream comprises a gas selected from the group consisting of CO, methane, and mixtures thereof.

12. The method of claim 11, wherein the carbon feedstock gas stream comprises CO, and wherein P_{CO} is between about 3 atm and about 1000 atm.

13. The method of claim 1, wherein the temperature of the product gas stream is at least about 500° C.

14. The method of claim 1, wherein the temperature of the product gas stream is at least about 850° C.

15. The method of claim 1, wherein the temperature of the product gas stream is at least about 900° C.

16. The method of claim 1, wherein the mixing of the heated catalyst gas stream and the carbon feedstock gas stream is substantially complete in less than about 10 msec.

17. The method of claim 1, further comprising recovering a single-wall carbon nanotube product from the product gas stream.

18. The method of claim 17, wherein the recovering comprises passing the product gas stream through a gas-permeable filter.

19. The method of claim 17, wherein at least about 90% of the carbon in the single-wall carbon nanotube product is single-wall carbon nanotubes.

20. The method of claim 17, wherein at least about 95% of the carbon in the single-wall carbon nanotube product is single-wall carbon nanotubes.

21. The method of claim 17, wherein at least about 99% of the carbon in the single-wall carbon nanotube product is single-wall carbon nanotubes.

22. The method of claim 17, wherein less than about 7 atom % of the single-wall carbon nanotube product is catalyst.

23. The method of claim 17, wherein less than about 4 atom % of the single-wall carbon nanotube product is catalyst.

24. The method of claim 17, wherein less than about 2 atom % of the single-wall carbon nanotube product is catalyst.

25. A method for producing single-wall carbon nanotubes, comprising:
(a) providing a catalyst precursor gas stream comprising
(i) a carrier gas and
(ii) a catalyst precursor comprising a plurality of catalyst precursor molecules, wherein the catalyst precursor molecules comprise one or more atoms of at least one transition metal selected from the group consisting of Group VIb elements and Group VIIIb elements, and wherein the catalyst precursor gas stream is at a temperature at which the catalyst precursor is stable;
(b) subjecting the catalyst precursor gas stream to electromagnetic radiation, wherein the electromagnetic radiation provides sufficient energy to photolyze the catalyst precursor and promote the initiation and growth of catalyst clusters and to form a catalyst cluster gas stream comprising a solution or a suspension of catalyst clusters;
(c) providing a carbon feedstock gas stream at a temperature above the minimum single-wall carbon nanotube formation initiation temperature; and
(d) mixing the carbon feedstock gas stream with the catalyst cluster gas stream to form a mixed gas stream, wherein the catalyst clusters reach a temperature sufficient to promote the initiation and growth of single-wall carbon nanotubes on the catalyst clusters and to form a product gas stream comprising the single-wall carbon nanotubes.

26. The method of claim 25, wherein the electromagnetic radiation is substantially coherent substantially monochromatic electromagnetic radiation.

27. The method of claim 25, wherein the electromagnetic radiation is provided from a flashlamp.

28. The method of claim 25, wherein the carrier gas is selected from the group consisting of CO, CO₂, methane, argon, nitrogen, and mixtures thereof.

29. The method of claim 28, wherein the catalyst precursor comprises a metal carbonyl.

30. The method of claim 29, wherein the metal carbonyl is selected from the group consisting of Fe(CO)₅, Ni(CO)₄, and mixtures thereof.

31. The method of claim 25, wherein the substantially coherent substantially monochromatic electromagnetic radiation has a peak wavelength of about 200 nm to about 300 nm.

32. The method of claim 25, wherein the carbon feedstock gas stream comprises a compound selected from the group consisting of CO, methane, and mixtures thereof.

33. The method of claim 32, wherein the carbon feedstock gas stream comprises CO, and wherein P_{CO} is at least about 3 atm.

34. The method of claim 25, wherein the temperature of the mixed gas stream is at least about 500° C.

35. The method of claim 25, wherein the temperature of the mixed gas stream is at least about 850° C.

36. The method of claim 25, wherein the temperature of the mixed gas stream is at least about 900° C.

37. The method of claim 25, wherein the mixing is substantially complete in less than about 10 msec.

38. The method of claim 25, further comprising recovering the single-wall carbon nanotube product from the product gas stream.

39. The method of claim 38, wherein the recovering step comprises passing the product gas stream through a gas-permeable filter.

40. The method of claim 38, wherein the recovering step comprises passing the product gas stream through a gas-permeable filter.

41. The method of claim 38, wherein at least about 90% of the carbon in the single-wall carbon nanotube product is single-wall carbon nanotubes.

42. The method of claim 38, wherein at least about 95% of the carbon in the single-wall carbon nanotube product is single-wall carbon nanotubes.

43. The method of claim 38, wherein at least about 99% of the carbon in the single-wall carbon nanotube product is single-wall carbon nanotubes.

44. The method of claim 38, wherein less than about 7 atom % of the single-wall carbon nanotube product is catalyst.

45. The method of claim 38, wherein less than about 4 atom % of the single-wall carbon nanotube product is catalyst.

46. The method of claim 38, wherein less than about 2 atom % of the single-wall carbon nanotube product is catalyst.

47. An apparatus for producing single-wall carbon nanotubes, comprising:
(a) a catalyst addition system, wherein the catalyst addition system is operable to provide a catalyst precursor gas stream comprising
(i) a carrier gas and
(ii) a catalyst precursor comprising a plurality of catalyst precursor molecules, wherein the catalyst precursor molecules comprise one or more atoms of at least one transition metal selected from the group consisting of Group VIb elements and Group VIIIb elements, and wherein the catalyst precursor gas stream is at a temperature at which the catalyst precursor is stable;
(b) a catalyst-formation zone, wherein the catalyst precursor gas stream is heated in the catalyst-formation zone to form a heated catalyst gas stream, and wherein the heated catalyst gas stream is at a temperature sufficient to promote the initiation and growth of catalyst clusters and to form a suspension of catalyst clusters in the heated catalyst gas stream;
(c) a carbon feedstock gas source operable to provide a carbon feedstock gas stream at a temperature above the minimum single-wall carbon nanotube formation initiation temperature; and
(d) a reactor, wherein the carbon feedstock gas stream and the heated catalyst gas stream are mixed to form a mixed gas stream, and wherein the catalyst clusters reach a temperature sufficient to promote the initiation and growth of single-wall carbon nanotubes on the catalyst clusters and to form a product gas stream comprising the single-wall carbon nanotubes.

48. An apparatus for producing single-wall carbon nanotubes, comprising:
(a) a catalyst addition system, wherein the catalyst addition system is operable to provide a catalyst precursor gas stream comprising
(i) a carrier gas and
(ii) a catalyst precursor comprising a plurality of catalyst precursor molecules, wherein the catalyst precursor molecules comprise one or more atoms of at least one transition metal selected from the group consisting of Group VIb elements and Group VIIIb elements, and wherein the catalyst precursor gas stream is at a temperature at which the catalyst precursor is stable;
(b) an electromagnetic radiation source operable to subject the catalyst precursor gas stream to electromagnetic radiation, wherein the electromagnetic radiation provides sufficient energy to photolyze the catalyst precursor and promote the initiation and growth of catalyst clusters and to form a catalyst cluster gas stream comprising a solution or a suspension of catalyst clusters;
(c) a carbon feedstock gas source operable to provide a carbon feedstock gas stream at a temperature above the minimum single-wall carbon nanotube formation initiation temperature; and
(d) a reactor, wherein the carbon feedstock gas stream with the catalyst cluster gas stream are mixed to form a mixed gas stream, and wherein the catalyst clusters reach a temperature sufficient to promote the initiation and growth of single-wall carbon nanotubes on the catalyst clusters and to form a product gas stream comprising the single-wall carbon nanotubes.
